(19) United States
(12) Patent Application Publication
(10) Pub. No.: US 2014/0088814 A1
(43) Pub. Date: Mar. 27, 2014

(54) DRIVING CONTROL EXCHANGING SYSTEM AND METHOD FOR AUTONOMOUS VEHICLE

(71) Applicant: HYUNDAI MOTOR COMPANY, Seoul (KR)

(72) Inventors: Byung Yong You, Suwon (KR); Young Chul Oh, Seongnam (KR)

(73) Assignee: HYUNDAI MOTOR COMPANY, Seoul (KR)

(21) Appl. No.: 13/693,866

(22) Filed: Dec. 4, 2012

(30) Foreign Application Priority Data
Sep. 24, 2012 (KR) 10-2012-0105675

(51) Int. Cl. G05D 1/00

(52) U.S. Cl. CPC G05D 1/0061
USPC 701/23

(57) ABSTRACT

Disclosed herein is a driving control exchanging method for an autonomous vehicle by which a driving control may be easily exchanged between a driver and an autonomous vehicle, acquisition of a driving control by a child or a person who cannot drive is prevented, and the relative laws can be complied, making it possible to safely and conveniently manage the autonomous vehicle.

### CROSS-REFERENCE TO RELATED APPLICATION

This application claims under 35 U.S.C. §119(a) the benefit of Korean Patent Application No. 10-2012-0105675 filed Sep. 24, 2012 the entire contents of which are incorporated herein by reference.

### BACKGROUND

(a) Technical Field

The present invention relates to a driving control exchanging system and method for an autonomous vehicle, and more particularly, to a driving control exchanging system and method for an autonomous vehicle by which an autonomous travel state of the vehicle and a manual travel state by a driver can be switched.

(b) Background Art

In recent years, various states in the country (e.g., Nevada) have passed a law allowing unmanned autonomous vehicles to travel on general roads. According to the law, an autonomous vehicle must switch a driving control back to a driver when the desired by the driver, and the driver may easily switch the driving control to the vehicle to operate the vehicle in an autonomous travel mode.

The method for exchanging a driving control between a vehicle and a driver must be easily performed to comply with the related laws, and the exchange should be have a safety mechanism so as to not be operated by a child or a person who is not capable of driving a vehicle.

For example, according to the law in Nevada, an autonomous vehicle is required to include an autonomous travel power switch which may be manipulated by a driver while driving without averted attention from the road, and is also required to exchange the driving control to the driver by a mechanism including at least a brake pedal, an acceleration pedal, or a steering wheel.

The items described as the background art are provided just to help in understanding of the background of the present invention, and shall not be construed to admit that they correspond to the technologies already known to those skilled in the art to which the present invention pertains.

### SUMMARY OF THE DISCLOSURE

An object of the present invention is to provide a driving control exchanging system and method for an autonomous vehicle by which a driving control may be easily exchanged between a driver and an autonomous vehicle, preventing acquisition of a driving control right by a child or a person who cannot drive, and complying with the relative laws, making it possible to safely and conveniently manage the autonomous vehicle.

In one embodiment, the present invention provides a driving control exchanging method for an autonomous vehicle, including: determining, by a controller including a memory and a processor, an operable minimum operation for a vehicle when a conversion request from an autonomous travel mode to a manual travel mode is made; and sequentially turning off, by the controller, a plurality of functions for during an autonomous travel of the vehicle to convert the vehicle mode to the manual travel mode when determined that a minimum operation of travel of the vehicle is operable.

In another embodiment, the present invention provides a driving control exchanging method for an autonomous vehicle, including: receiving, by the controller, an input of a mode conversion switch by the driver; determining, by the controller, when the input corresponds to a conversion request from an autonomous travel mode to a manual travel mode or a conversion request from the manual travel mode to the autonomous travel mode; determining, by the controller, an operable minimum operation for a vehicle travel when a conversion request from an autonomous travel mode to a manual travel mode is made; sequentially turning off, by the controller, a plurality of functions during an autonomous travel of the vehicle to convert the mode of the vehicle to the manual travel mode when determined that a minimum operation of travel is operable; in response to determining, by the controller, that a request for conversion from a manual travel mode to an automatic travel mode is made, confirming existence of modules controlling functions necessary to perform an autonomous travel of the vehicle and performing a necessary initialization operation; and in response to the initialization operation, sequentially turning on, by the controller, the modules for performing an autonomous travel of the vehicle and converting the mode of the vehicle into an autonomous travel mode.

According to the present invention, a driving control may be easily exchanged between a driver and an autonomous vehicle, operation of a driving control by a child or a person who cannot drive may be prevented, and the relative laws may be complied with, making it possible to safely and conveniently manage the autonomous vehicle.

### BRIEF DESCRIPTION OF THE DRAWINGS

The above and other features, objects and other advantages of the present invention will now be described in detail with reference to exemplary embodiments thereof illustrated in the accompanying drawings which are given hereinbelow by way of illustration only, and thus are not limitative of the present invention, and wherein:

FIG. 1 is an exemplary flowchart illustrating a driving control for an autonomous vehicle, according to an exemplary embodiment of the present invention;

FIG. 2 is an exemplary view illustrating a display when an operability determining step is performed, according to an exemplary embodiment of the present invention;

FIG. 3 is an exemplary view illustrating sequence combinations of apparatuses to be operated, which can be proposed in the operability determining step, according to an exemplary embodiment of the present invention;

FIG. 4 is an exemplary table of a multi-stage manual conversion steps, according to an exemplary embodiment of the present invention\;

FIG. 5 is an exemplary table of a multi-stage automatic conversion steps, according to an exemplary embodiment of the present invention; and

FIG. 6 is an exemplary view illustrating an electronic control unit for detecting a driving control exchanging method for an autonomous vehicle, according to an exemplary embodiment of the present invention.

It should be understood that the accompanying drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF PREFERRED EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

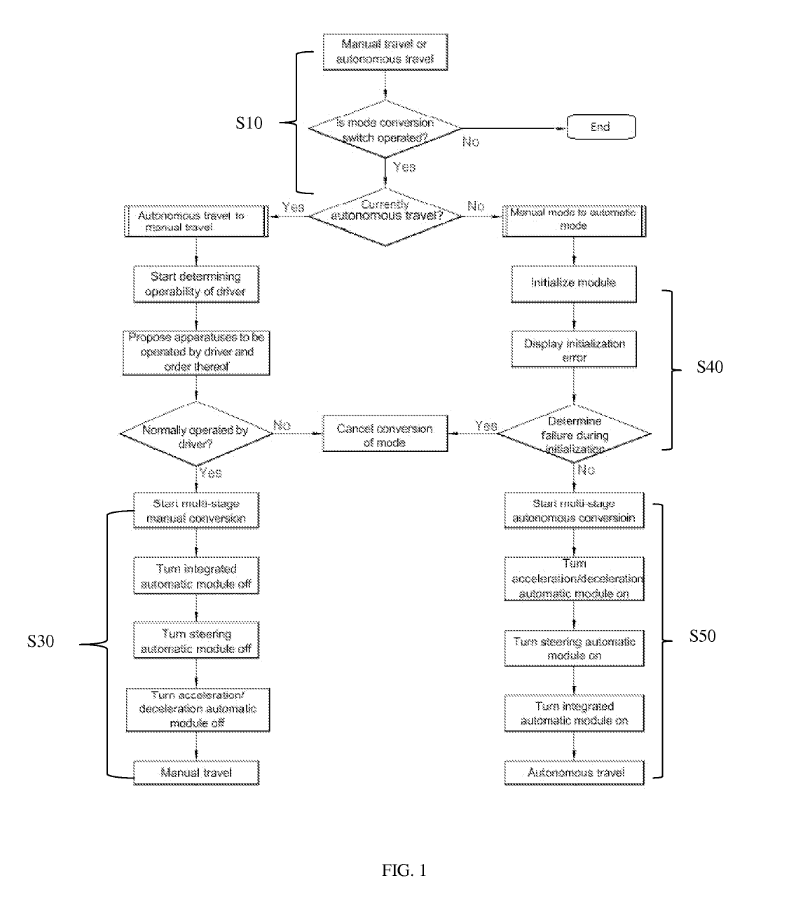

Referring to FIG. 1, a driving control exchanging method for an autonomous vehicle according to an embodiment of the present invention, includes: a mode conversion request determining step (S10) of receiving, by a controller, an input of a mode conversion switch by the driver, and determining, by the controller, the input as a conversion request from an autonomous travel mode to a manual travel mode or a conversion request from the manual travel mode to the autonomous travel mode; an operability determining step (S20) of determining, by the controller, an operable minimum operation for a vehicle travel when a conversion request from an autonomous travel mode to a manual travel mode is made; a multi-stage manual mode converting step (S30) of sequentially turning off, by the controller, a plurality of functions for performing an autonomous travel of the vehicle to convert the mode to the manual travel mode in response to determining that a vehicle travel is operable; a module initializing step (S40) of, in response to determining the conversion request from a manual travel mode to an automatic travel mode is made, confirming, by the controller, existence of modules controlling the functions necessary to perform an autonomous travel of the vehicle and performing, by the controller, a initialization operation; and a multi-step autonomous conversion step (S50) of, in response to the module initializing step (S40), sequentially turning on, by the controller the modules for performing an autonomous travel of the vehicle and converting the mode of the vehicle into an autonomous travel mode.

In other words, if a driver operates a mode conversion switch, it may be determined, by the controller, to be a conversion request to a manual travel mode when the current state is an autonomous travel state and it may be determined to be a conversion request to an autonomous travel state when the current state is a manual travel state. When the determination result corresponds to the conversion request to a manual travel mode, acquisition of a driving control by a child or a person who cannot drive may be prevented so the relative laws may be complied with through the operability determining step (S20), and the driving control may be gradually transferred to the driver so the mode of the vehicle may be converted to the manual travel mode through the multi-stage manual conversion step (S30), whereas when the determination result corresponds to the conversion request to an autonomous travel state, it may be determined, by the controller, whether the mode of the vehicle may be converted to the autonomous travel mode through the module initializing step (S40) and the state of the vehicle may be gradually converted to the autonomous travel state through the multi-stage autonomous conversion step (S50) so the driving control of the vehicle may be safely transferred to the vehicle.

In the operability determining step (S20), the controller may determine when a vehicle travel is operable according to the driver operating at least two apparatuses including at least one of a brake pedal, an acceleration pedal, and a steering wheel depending on a specific order. In other words, is the controller may determine whether a travel of the vehicle by a driver is operable according to whether the driver manipulates at least one of the brake pedal, the acceleration pedal, and the steering wheel, a separate switch, or other apparatuses of the vehicle in a specific order.

Moreover, the specific order of the driver manipulation may be an order determined in advance and known by the driver or may be an order proposed to the driver at random whenever the controller determines that a conversion request to the manual travel mode is made, and then, the vehicle may propose apparatuses to be operated and an order thereof and the driver may operate the proposed apparatuses according to the proposed order.

For example, in the operability determining step (S20), apparatuses to be operated and an order thereof may be proposed, by the controller, to the driver through a display unit such as a head up display (HUD) as exemplified in FIG. 2. As illustrated in FIG. 2, a steering wheel, a brake pedal, and an acceleration pedal, may be sequentially displayed on the display unit and may be powered on and off so the driver may operate the apparatuses according to the determined order. Moreover, when the driver manipulates the brake pedal, the acceleration pedal, and the steering wheel in sequence according to the order proposed by the driver, the controller may determine that the driver is capable of operating the vehicle.

Thus, the driving control of the vehicle may be switched only to a person who is capable of operating the brake pedal, the acceleration pedal, and the steering wheel at least according to the determined or proposed order for the driver to perform a manual operation without switching the driving control of the vehicle to a child or a person who cannot operate the apparatuses necessary for the operation. However, in the operability determining step (S20), an operation of the brake pedal, the acceleration pedal, or the steering wheel operated by the driver does not control the movement of the vehicle but is used only to determine whether an operation is performed by the driver.

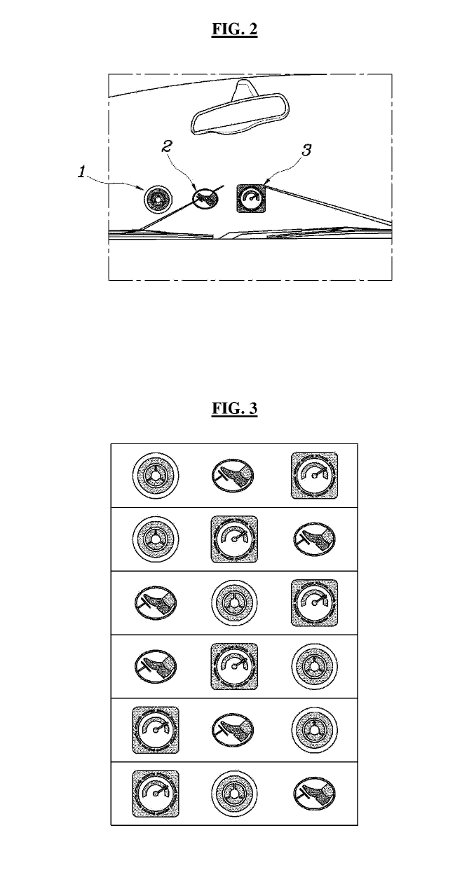

For reference, FIG. 3 illustrates a table of various examples of proposing apparatuses to be operated by a driver and an order thereof. The symbols denoting brake pedals, acceleration pedals, and steering wheels are listed in a plurality of rows in various orders, and the controller may arbitrarily select one of the rows and display the selected row to the driver and may determine whether the driver sequentially manipulates the apparatuses according to the order of the symbols listed in the selected row to perform the operability determining step (S20).

As illustrated in FIG. 4, in the multi-stage manual mode converting step (S30), the controller sequentially performs an integrated automatic module off step (S31) of turning off a complete autonomous travel function during a steering, accelerating, and decelerating operation of the vehicle converting the vehicle state into an autonomous travel state without lane change control, a steering automatic module off step (S32) of turning off the automatic steering function and converting the vehicle state into a state in which only the acceleration and deceleration of the vehicle is automatically performed; and an acceleration and deceleration automatic module off step (S33) of turning off the automatic accelerating and decelerating function and converting the vehicle mode to a completely manual mode.

In addition, when the controller performs the integrated automatic module off step (S31), the vehicle state may be converted, by the processor, from a completely autonomous travel state including a change of a lane to a state of autonomously traveling without lane change control in which the controller performs both a lane keeping assist system (LKAS) function and a smart cruise control (SCC) function.

Furthermore, when the steering automatic module off step (S32) is performed by the controller, the LKAS function may be stopped and only the SCC function is maintained, while the vehicle maintains only the automatic acceleration and deceleration function. In addition, when the acceleration and deceleration automatic module off step (S33) is performed by the controller, the SCC function may be turned off to convert the vehicle mode to a completely manual travel mode, so a driving control may be gradually transferred to the driver to allow the driver to perform steering, acceleration, and deceleration operations, while preventing an unstable state due to abrupt conversion of a driving control.

Moreover, when the controller determines in the mode conversion request determining step (S10) that a conversion request from a manual travel mode to an automatic travel mode is made, the controller performs a module initializing step (S40) and the multi-stage autonomous conversion step (S50) so the vehicle mode is converted to an autonomous travel mode. Specifically, the controller performs the module initializing step (S40) on an acceleration and deceleration automatic module, a steering automatic module for maintaining a lane control, and an integrated automatic module with no driver control.

Thus, a danger due to transfer of the driving control right in an inappropriate state of the vehicle may be prevented since the driving control of the vehicle is switched to the vehicle after the controller determines whether any error is present in the acceleration and deceleration automatic module, the steering automatic module, and the integrated automatic module and the vehicle state is initialized, by the controller, to a state in which the acceleration and deceleration automatic module, the steering automatic module, and the integrated automatic module may be operated immediately.

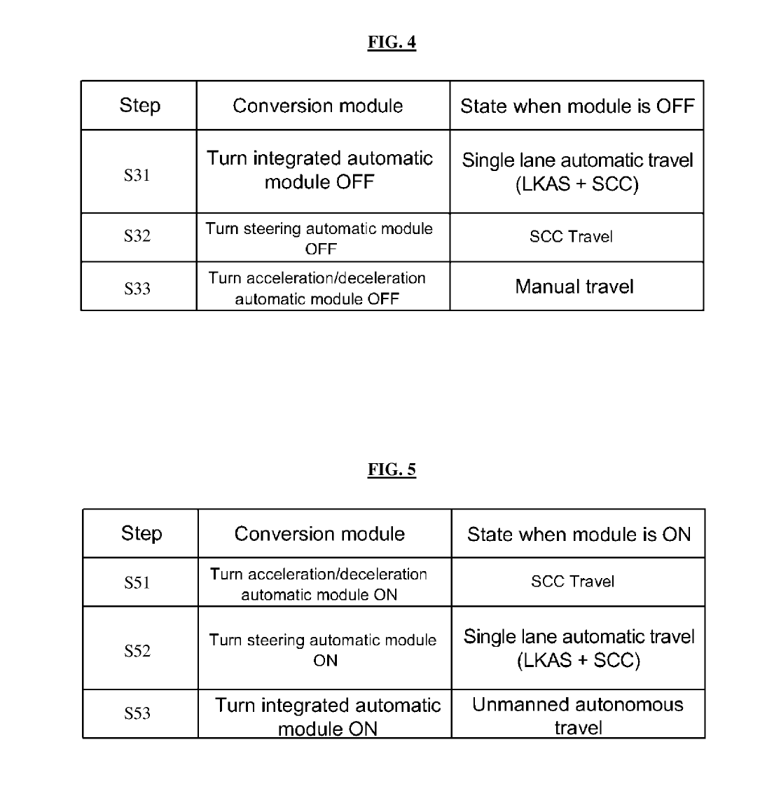

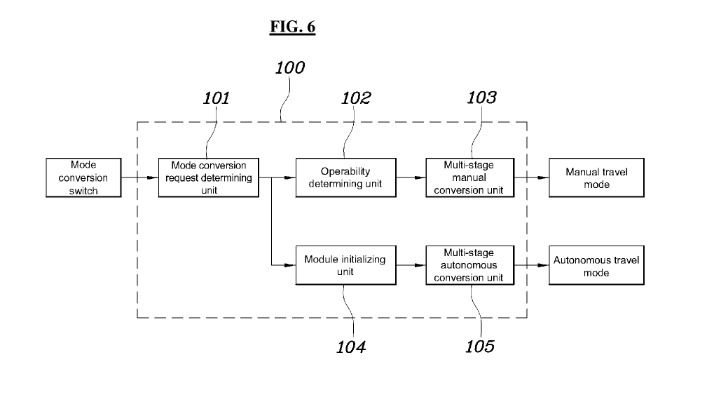

As illustrated in FIG. 5, in the multi-stage autonomous conversion step (S50), after the controller turns on the acceleration and deceleration automatic module (S51) to automatically accelerate and decelerate the vehicle, the controller may turn on the steering automatic module (S52) and the vehicle may be autonomously driven while maintaining lane control. Furthermore, the state of the vehicle may be converted, by the controller, to a completely autonomous travel state by turning on the integrated automatic module (S53).

Additionally, since the vehicle mode is converted, by the controller, from the manual travel mode to the autonomous travel mode gradually in stages, the travel mode may be converted more safely.

Moreover, FIG. 6 illustrates an example of the controller 100 configured to perform the driving control exchanging method for an autonomous vehicle according to the present invention, which includes a mode conversion request determining unit 101 for receiving an input of the mode conversion switch and determining whether the input corresponds to a conversion request to an opposite mode according to whether the current vehicle travel mode is an autonomous travel mode or a manual travel mode, an operability determining unit 102 for performing the operability determining step (s20), a multi-stage manual conversion unit 103 for performing the multi-stage manual conversion step (S30), a module initializing unit 104 for performing the module initializing step (S40), and a multi-stage autonomous conversion unit 105 for performing the multi-stage autonomous conversion step (S50).

Of course, the various parts may be packaged in separate electronic control chips in an arbitrary combination or all parts may be packaged in a single electronic control chip.

While the present invention has been illustrated and described with reference to exemplary embodiments, it is apparent to those skilled in the art to which the present invention pertains that the present invention may be variously improved and changed without departing from the scope of the present invention.

1. A driving control exchanging method for an autonomous vehicle, comprising:
determining, by a controller, an operable vehicle operation when a conversion request of a vehicle mode from an autonomous travel mode to a manual travel mode is made by a driver; and
sequentially turning off, by the controller, a plurality of functions for performing an autonomous travel of the vehicle to convert the vehicle mode to the manual travel mode in response to determining an operable travel of the vehicle,
wherein determining, by the controller, the operable vehicle operation includes determining when the driver operates at least two apparatuses selecting from the group consisting of: a brake pedal, an acceleration pedal, and a steering wheel in a specific order.

2. (canceled)

3. The driving control exchanging method of claim 1, wherein the controller sets the specific order of the apparatuses and displays the order on a display unit.

4. The driving control exchanging method of claim 1, wherein the controller determines an operable vehicle operation when the driver manipulates the brake pedal, the acceleration pedal, and the steering wheel in the order set by the driver.

5. The driving control exchanging method of claim 1, further comprising:
turning off, by the controller, a complete autonomous travel function during a steering, accelerating and decelerating operation of the vehicle and converting the vehicle state into an autonomous travel state while maintaining lane control;
turning off, by the controller, the automatic steering function and converting the vehicle state into a state in which only the acceleration and deceleration function is automatically performed; and
turning off, by the controller, the automatic accelerating and decelerating function and converting the vehicle mode to a manual mode.

6. The driving control exchanging method of claim 1, further comprising:
receiving, by the controller, an input of a mode conversion switch by the driver; and
determining, by the controller, when the input corresponds to the conversion request from an autonomous travel mode to a manual travel mode and the conversion request from the manual travel mode to the autonomous travel mode.

7. The driving control exchanging method of claim 6, wherein further comprising:
in response to determining, by the controller, the conversion request from the manual travel mode to the automatic travel mode confirming, by the controller, existence of a plurality of modules to operate the autonomous travel;
performing, by the controller, an initialization operation;
turning on, by the controller, the modules operating the autonomous travel; and
converting, by the controller, the vehicle mode into the autonomous travel mode.

8. The driving control exchanging method of claim 7, wherein the controller performs the initialization operation on an acceleration and deceleration automatic module, a steering automatic module, and an integrated automatic module.

9. The driving control exchanging method of claim 8, wherein in response to turning on the acceleration and deceleration automatic module and the steering automatic module, converting, by the controller, the vehicle mode into the autonomous travel state by turning on the integrated automatic module.

10. A driving control exchanging method for an autonomous vehicle, comprising:
receiving, by a controller, an input of a mode conversion switch by a driver;
determining, by the controller, when the input corresponds to a conversion request from an autonomous travel mode to a manual travel mode and when the input corresponds to the conversion request from the manual travel mode to the autonomous travel mode;
determining, by the controller, an operable vehicle operation for a vehicle travel when the conversion request of a vehicle mode from an autonomous travel mode to a manual travel mode is made, wherein determining, by the controller, the operable vehicle operation includes determining when the driver operates at least two apparatuses selecting from the group consisting of: a brake pedal, an acceleration pedal, and a steering wheel in a specific order;
sequentially turning off, by the controller, a plurality of functions for performing an autonomous travel of the vehicle to convert the vehicle mode to the manual travel mode in response to determining an operable travel of the vehicle;
in response to determining the conversion request from a manual travel mode to an automatic travel mode, confirming, by the controller, existence of a plurality of modules to operate the autonomous travel of the vehicle;
performing, by the controller, an initialization operation on the plurality of modules;
sequentially turning on, by the controller, the plurality of modules for operating the autonomous travel of the vehicle; and
converting the vehicle mode into the autonomous travel mode.

11. The driving control exchanging method of claim 10, wherein the controller sets a plurality of apparatuses to be operated to determine an operable vehicle operation and an order thereof.

12. The driving control exchanging method of claim 11, further comprising:
turning off, by the controller, the autonomous travel function;
converting, by the controller, the vehicle state into the autonomous travel state while maintaining lane control;
turning off, by the controller, the automatic steering function;
converting, by the controller, the vehicle state into a state in which the acceleration and deceleration of the vehicle is automatically performed;
turning off, by the controller, the automatic accelerating and decelerating function; and
converting, by the controller, the vehicle mode to a completely manual mode.

13. The driving control exchanging method of claim 10, wherein the initialization operation is performed, by the controller, on an acceleration and deceleration automatic module, a steering automatic module, and an integrated automatic module.

14. (canceled)

15. A system for exchanging a driving control for an autonomous vehicle, comprising
a controller configured to:
determine an operable vehicle operation when a conversion request of a vehicle mode from an autonomous travel mode to a manual travel mode is made by a driver; and
sequentially turn off a plurality of functions for performing an autonomous travel of the vehicle to convert the vehicle mode to the manual travel mode in response to determining an operable travel of the vehicle.

16. (canceled)

17. The system of claim 15, wherein the controller is further configured to:
turn off a complete autonomous travel function during a steering, accelerating and decelerating operation of the vehicle and converting the vehicle state into an autonomous travel state while maintaining lane control;
turn off the automatic steering function and converting the vehicle state into a state in which only the acceleration and deceleration function is automatically performed; and
turning off the automatic accelerating and decelerating function and converting the vehicle mode to a manual mode.

18. The system of claim 15, wherein the controller is further configured to:
receive an input of a mode conversion switch by the driver; and
determine when the input corresponds to the conversion request from an autonomous travel mode to a manual travel mode and the conversion request from the manual travel mode to the autonomous travel mode.

19. The system of claim 15, wherein the controller is further configured to:
confirm existence of a plurality of modules to operate the autonomous travel, in response to determining the conversion request from the manual travel mode to the automatic travel mode;
perform an initialization operation;
turn on the modules operating the autonomous travel; and
convert the vehicle mode into the autonomous travel mode.

20. The system of claim 19, wherein the controller is configured to perform the initialization operation on an acceleration and deceleration automatic module, a steering automatic module, and an integrated automatic module.

21. The system of claim 19, wherein the controller is further configured to convert the vehicle mode into the autonomous travel state by turning on the integrated automatic module in response to turning on the acceleration and deceleration automatic module and the steering automatic module.
